(19) United States
(12) Patent Application Publication
(10) Pub. No.: US 2006/0218040 A1
(43) Pub. Date: Sep. 28, 2006

(54) Methods, systems, and computer program products for ordering food/beverage items at a food/beverage establishment using a mobile terminal

(76) Inventor: Rohan G. Sabapathypillai, Raleigh, NC (US)

Correspondence Address: Rohan G. Sabapathypillai, 1700 Wysong Court, Raleigh, NC, 27612, US

(21) Appl. No.: 11/082,459

(22) Filed: Mar. 17, 2005

(51) Int. Cl. G06Q 30/00

(52) U.S. Cl. 705/15

(57) ABSTRACT

A method of taking a food/beverage order at a food/beverage establishment includes receiving a menu selection from a customer mobile terminal in the food/beverage establishment at a dedicated restaurant transceiver over a wireless data connection. The menu selection designates at least one food/beverage item. The menu selection may be received responsive to transmitting food/beverage menu content from the dedicated restaurant transceiver to the mobile terminal. Also, a method of ordering food/beverage items at a food/beverage establishment includes transmitting a menu selection designating at least one food/beverage item from a customer mobile terminal in the food/beverage establishment to a dedicated restaurant transceiver over a wireless data connection. The menu selection may be transmitted responsive to receiving food/beverage menu content from the dedicated restaurant transceiver. Related devices and computer program products are also discussed.

### FIELD OF THE INVENTION

The present invention relates to the field of data networking, and more particularly, to methods of networking mobile terminals in food/beverage establishments and related devices.

### BACKGROUND OF THE INVENTION

Restaurants, bars, coffee shops, and/or other food/beverage establishments often allow customers/patrons to place their food and/or beverage order at a counter. In such circumstances, an employee of the establishment interacts with the customer and enters the customer's order. As the number of employees working in the establishment at any one given time is limited, long lines may form at the counter when a large number of customers are attempting to order food and/or beverages. The orders are typically taken based on the position of each customer in the line. Accordingly, while the customers wait in line, they may be unable to perform other, more productive tasks. As such, if the lines appear to be too long, some customers may be dissuaded from frequenting the food/beverage establishment altogether.

In addition, the employee behind the counter may make a mistake in entering a customer's order. As such, the customer may receive one or more items that he did not order, and/or may not receive one or more items that he did order. This may result in customer dissatisfaction, and in some instances, illness. For example, a customer who is allergic to nuts may order an ice cream sundae without nuts. If the employee neglects to include this preference in entering the order, the customer may have an allergic reaction when the sundae is consumed. This may also result in reduced business, bad publicity, and/or loss of revenue for the restaurant.

In some instances, a number of customers may gather at the counter such that the employee behind the counter cannot discern the order in which the customers arrived. For example, at a bar/nightclub, multiple patrons may gather around the bar counter and attempt to place an order with the bartender. However, the bartender may not be able to tell which of the patrons arrived first. As such, orders may be taken out of order, and patrons may become impatient and/or otherwise dissatisfied with the bartender and/or the bar/nightclub. This may result in reduced tipping, loss of popularity, and/or reduced business, which may lead to a loss of revenue for the bar/nightclub.

In sit-down restaurants, where patrons are served by a waitperson, it is known to provide patrons with paging devices to alert them when their table is ready. In some instances, the paging devices may be included in a more complex personal digital assistant (PDA) that a restaurant may provide to patrons for use while they wait. For example, patrons may use the PDA to read news, watch movie previews, and/or read the restaurant's menu while they wait for a table. However, due to the volume of customers who may be waiting for a table at a restaurant at any given time, a large number of PDAs may be required, which may impose unreasonable costs on the restaurant. In addition, as the restaurant may not have a means for tracking the identities of the customers to whom PDAs are given, some customers may walk-off with or may otherwise not return a PDA to the restaurant. As such, buying and/or maintaining such PDAs may not be economically feasible for the restaurant.

### SUMMARY OF THE INVENTION

According to some embodiments of the present invention, a method of taking a food/beverage order at a food/beverage establishment includes receiving a menu selection from a customer mobile terminal in the food/beverage establishment over a wireless data connection. The menu selection may designate at least one food/beverage item. The menu selection may be received responsive to food/beverage menu content that is transmitted to the mobile terminal from a dedicated restaurant transceiver.

According to further embodiments of the present invention, a method of receiving a food/beverage order at a food/beverage establishment includes receiving a menu request from a customer mobile terminal in the food/beverage establishment at a dedicated restaurant transceiver and establishing an ad-hoc wireless data connection with the mobile terminal responsive to the menu request. Food/beverage menu content including a plurality of available food/beverage items is transmitted to the mobile terminal, and a menu selection designating at least one of the plurality of food/beverage items is received from the mobile terminal at the dedicated restaurant transceiver using the ad-hoc wireless data connection.

In some embodiments, the food/beverage menu content may be transmitted to the mobile terminal using the ad-hoc wireless data connection.

In other embodiments, the method may further include receiving a plurality of menu selections from a respective plurality of customer mobile terminals in the food/beverage establishment, and forming a virtual queue including a list of the plurality of customer mobile terminals and/or received menu selections based on an order of receipt of each menu selection. In some embodiments, an aggregate queue including a combination of the virtual queue and a queue of manually-entered orders may be formed based on the order of receipt of each menu selection and based on an order of receipt of each manually-entered order. Also, an approximate food/beverage wait time may be transmitted to a respective one of the plurality of customer mobile terminals based on the aggregate queue.

In some embodiments, the method may further include detecting the mobile terminal within a predetermined proximity of the restaurant transceiver, and transmitting a message to the mobile terminal responsive to detecting the mobile terminal. A menu request may be received from the mobile terminal responsive to the transmitted message.

In other embodiments, the method may further include displaying a connection number in the food/beverage establishment. A menu request may be received via a call from the mobile terminal at the displayed number.

In some embodiments, the food/beverage establishment may be a fast food restaurant, a coffee shop, and/or a bar. The wireless data connection may be at least one of an infrared, Bluetooth, Wi-Fi, and/or PLMN connection.

In other embodiments, the method may further include displaying the received menu selection at a kitchen and/or preparation area for the food/beverage establishment. In addition, a signal may be transmitted to the mobile terminal when the at least one of the food/beverage items designated by the menu selection is ready, and the at least one of the food/beverage items designated by the menu selection may be provided to a user of the mobile terminal responsive to receiving the menu selection.

In some embodiments, the method may further include identifying an account associated with the mobile terminal and billing the account based on the at least one of the plurality of food/beverage items designated by the menu selection.

In other embodiments, receiving a menu request may include receiving a menu request for a first language version of the food/beverage menu content. The first language version of the food/beverage menu content may be transmitted responsive to receiving the menu request.

According to some embodiments of the present invention, a method of ordering food/beverage items at a food/beverage establishment includes transmitting a menu selection from a customer mobile terminal in the food/beverage establishment to a dedicated restaurant transceiver over a wireless data connection. The menu selection may designate at least one food/beverage item. The menu selection may be transmitted responsive to receiving food/beverage menu content from the dedicated restaurant transceiver.

According to further embodiments of the present invention, a method of ordering food/beverage items at a food/beverage establishment includes transmitting a menu request from a customer mobile terminal in the food/beverage establishment to a dedicated restaurant transceiver, and establishing an ad-hoc wireless data connection with the dedicated restaurant transceiver after transmitting the connection request. Food/beverage menu content including a plurality of available food/beverage items is received from the dedicated restaurant transceiver and displayed at the mobile terminal. A menu selection designating at least one of the plurality of food/beverage items is received at the mobile terminal and transmitted to the dedicated restaurant transceiver using the ad-hoc wireless data connection.

In some embodiments, the food/beverage menu content may be received from the dedicated restaurant transceiver using the ad-hoc wireless data connection.

In other embodiments, transmitting a menu request may include transmitting a menu request for a first language version of the food/beverage menu content. The first language version of the food/beverage menu content may be received responsive to transmitting the menu request.

In some embodiments, the method may further include transmitting account information associated with the mobile terminal to the restaurant transceiver to pay for the food/beverage items.

In other embodiments, transmitting a menu request may include calling a connection number displayed in the food/beverage establishment and/or transmitting the menu request responsive to receiving a text message from the restaurant transceiver.

In some embodiments, the method may further include receiving an approximate food/beverage wait time at the mobile terminal from the restaurant transceiver based on an order of receipt of the menu selection.

In other embodiments, the method may further include receiving a signal at the mobile terminal from the restaurant transceiver when the at least one of the plurality of food/beverage items designated by the menu selection is ready.

According to some embodiments of the present invention, a food/beverage ordering system for taking a food/beverage order at a food/beverage establishment includes a dedicated restaurant transceiver. The dedicated restaurant transceiver is configured to transmit food/beverage menu content to a customer mobile terminal in the food/beverage establishment and receive a menu selection designating at least one food/beverage item from the mobile terminal over an ad-hoc wireless data connection.

In some embodiments, the restaurant transceiver may be configured to transmit the food/beverage menu content to the mobile terminal over the wireless data connection and receive the menu selection responsive to the transmitted food/beverage menu content.

In other embodiments, the restaurant transceiver may be further configured to receive a menu request from the mobile terminal. The food/beverage ordering system may further include a controller configured to establish the ad-hoc wireless data connection with the mobile terminal responsive to the received menu request.

In some embodiments, the restaurant transceiver may be configured to receive a menu request for a first language version of the food/beverage menu content from the mobile terminal. The controller may be configured to provide the first language version of the food/beverage menu content responsive to the received menu request. The restaurant transceiver may be configured to transmit the first language version of the food/beverage menu content to the mobile terminal using the ad-hoc wireless data connection.

In other embodiments, the controller may be further configured to identify an account associated with the mobile terminal and bill the account based on the transmitted menu selection.

In some embodiments, the food/beverage ordering system may further include a menu display configured to display a connection number. The restaurant transceiver may be configured to receive a call from the mobile terminal at the displayed number, and the controller may be configured to accept the call to establish the ad-hoc wireless data connection.

In other embodiments, the restaurant transceiver may be further configured to transmit a message to the mobile terminal and receive the menu request from the mobile terminal responsive to the transmitted message.

In some embodiments, the controller may be configured to detect the mobile terminal within a predetermined proximity of the restaurant transceiver. The restaurant transceiver may be configured to transmit the message to the mobile terminal responsive to detecting the mobile terminal.

In other embodiment, the restaurant transceiver may be configured to transmit a signal to the mobile terminal when the at least one of the food/beverage items designated by the menu selection is ready.

In some embodiments, the food/beverage establishment may be at least one of a fast food restaurant, a coffee shop, and/or a bar. The wireless data connection may be at least one of an infrared, Bluetooth, Wi-Fi, and/or PLMN connection.

In other embodiments, the restaurant transceiver may be configured to receive a plurality of menu selections from a respective plurality of mobile terminals in the food/beverage establishment. The controller may be configured to form a virtual queue including a list of the plurality of mobile terminals and/or received menu selections based on an order of receipt of each menu selection. The controller may be further configured to form an aggregate queue including a combination of the virtual queue and a queue of manually-entered orders based on the order of receipt of each menu selection and based on an order of receipt of each manually-entered order. The restaurant transceiver may be further configured to transmit an approximate food/beverage wait time to a respective one of the plurality of mobile terminals based on the aggregate queue.

According to some embodiments of the present invention, a mobile terminal includes a transceiver configured to receive food/beverage menu content from a dedicated restaurant transceiver in a food/beverage establishment. The mobile terminal transceiver is further configured to transmit a menu selection designating at least one food/beverage item to the dedicated restaurant transceiver over an ad-hoc wireless data connection.

In some embodiments, the transceiver may be configured to receive food/beverage menu content from the restaurant transceiver over the wireless data connection and transmit the menu selection responsive to the received food/beverage menu content.

In other embodiments, the transceiver may be further configured to transmit a menu request to the restaurant transceiver. The mobile terminal may further include a controller configured to establish the ad-hoc wireless data connection with the restaurant transceiver after the transmitted menu request.

In some embodiments, the controller may be configured to request a first language version of the food/beverage menu content. The transceiver may be configured to transmit a menu request for the first language version of the food/beverage menu content and receive the first language version of the food/beverage menu content from the restaurant transceiver.

In other embodiments, the controller may be further configured to provide account information associated with the mobile terminal to the restaurant transceiver using the wireless data connection to pay for the at least one food/beverage item.

In some embodiments, the mobile terminal transceiver may be configured to transmit a menu request responsive to receiving a message from the restaurant transceiver and/or by calling a connection number displayed in the food/beverage establishment.

Computer program products for operating a mobile terminal according to exemplary embodiments of the present invention are also provided.

### BRIEF DESCRIPTION OF THE DRAWINGS

FIG. 1 is a block diagram illustrating food/beverage ordering systems and methods according to some embodiments of the present invention.

FIG. 2 is a block diagram illustrating a mobile terminal and methods according to some embodiments of the present invention.

FIG. 3 is a block diagram illustrating a food/beverage ordering system and methods according to some embodiments of the present invention.

FIGS. 4A and 4B are flowcharts illustrating exemplary operations for taking a food/beverage order at a food/beverage establishment according to some embodiments of the present invention.

FIGS. 5A and 5B are a flowcharts illustrating exemplary operations for ordering food/beverage items at a food/beverage establishment using a mobile terminal according to some embodiments of the present invention.

### DETAILED DESCRIPTION OF EMBODIMENTS OF THE INVENTION

The present invention will now be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by those of skill in the art, the present invention may be embodied as methods, devices. Accordingly, the present invention may take the form of a hardware embodiment, a software embodiment or an embodiment combining software and hardware aspects. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, regions, steps, operations, elements, and/or components, but do not preclude the presence or addition of one or more other features, regions, steps, operations, elements, components, and/or groups thereof.

As will be appreciated by one of skill in the art, the present invention may be embodied as a method, device, and/or computer program product. Accordingly, the present invention may take the form of an entirely hardware embodiment, an entirely software embodiment or an embodiment combining software and hardware aspects, generally referred to herein as a “circuit.”

Computer program code for carrying out operations of the present invention may be written in an object oriented programming language such as Java®, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package.

The present invention is described below with reference to flowchart illustrations and/or block diagrams of methods, apparatus (mobile terminals) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart illustration and/or block diagram block or blocks.

The computer program instructions may also be loaded onto a computer or other programmable data processor to cause a series of operational steps to be performed on the computer or other programmable processor to produce a computer implemented process such that the instructions that execute on the computer or other programmable processor provide steps for implementing the functions or acts specified in the flowchart illustration and/or block diagram block or blocks.

It will also be understood that although the terms first, second, etc. are used herein to describe various elements, these elements should not be limited by these terms. These terms are only used to distinguish one element or embodiment from another element or embodiment. Thus, a first element or embodiment could be termed a second element or embodiment, and similarly, a second element or embodiment may be termed a first element or embodiment without departing from the teachings of the present invention.

It should be understood, that, as used herein, the term “mobile terminal” may include, but is not limited to, a cellular radiotelephone; a pager; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; and a conventional laptop and/or palmtop portable computer that includes a radiotelephone or other transceiver.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present invention may arise from a recognition that it may be advantageous for a customer in a food/beverage establishment to enter his own food/beverage order. In particular, this may improve accuracy of the order, as well as allow the customer to engage in more productive activities than would be possible while standing in line.

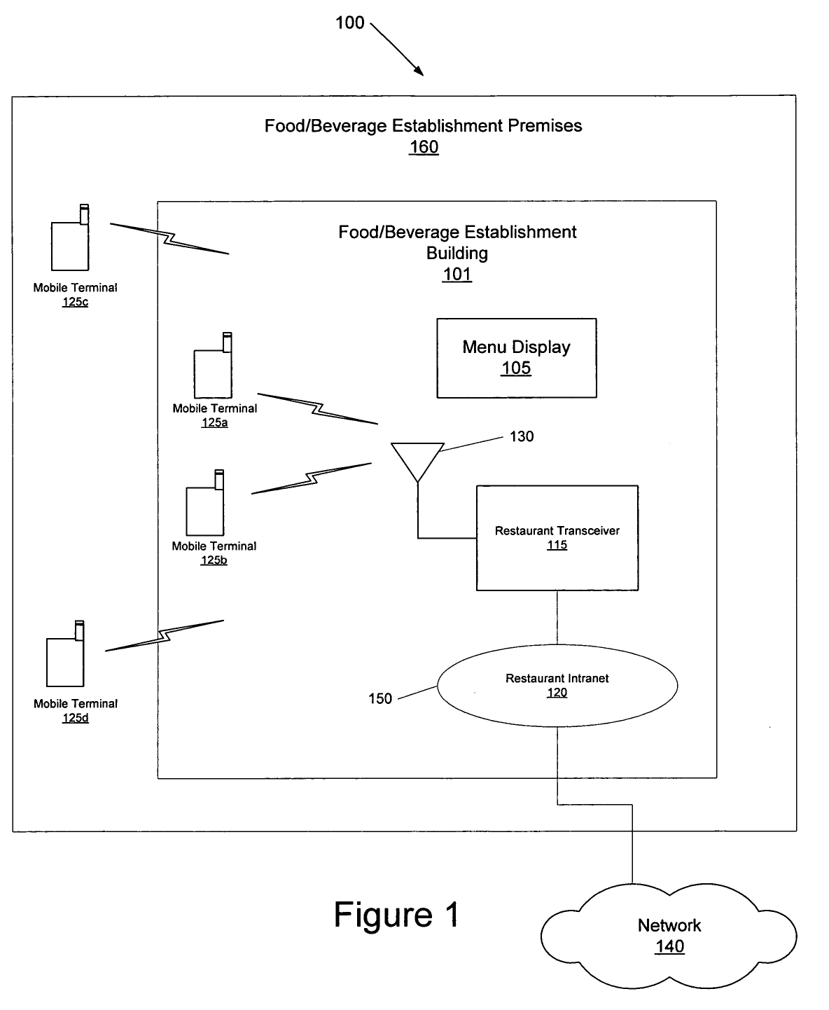

FIG. 1 is a block diagram illustrating food/beverage ordering systems and methods according to some embodiments of the present invention. As shown in FIG. 1, a food/beverage establishment 100 may include a menu display 105, a dedicated restaurant transceiver 115, a restaurant intranet 120, and plurality of customer mobile terminals 125a to 125d. Some of the mobile terminals 125a and 125b may be inside the food/beverage establishment building 101, while some mobile terminals 125c and 125d may be outside the food/beverage establishment building 101, such as in the food/beverage establishment parking lot, at an outdoor table on the food/beverage establishment premises 160, or within another predetermined proximity of the food/beverage establishment building 101. As used herein, a “food/beverage establishment” may include a fast food restaurant, coffee shop, bar/nightclub, and/or any other establishment where food and/or beverages are served. In addition, a food/beverage establishment may include areas inside the food beverage establishment building, in the food/beverage establishment parking lot and/or otherwise on the food/beverage establishment premises, and/or areas surrounding and/or immediately adjacent to the food/beverage establishment premises.

Still referring to FIG. 1, the dedicated restaurant transceiver 115 may be a local area transceiver located in the food/beverage establishment building 101 and/or otherwise on the food beverage establishment premises 160, and may be configured to transmit and/or receive data relating to the food/beverage establishment 100. The dedicated restaurant transceiver 115 may be configured to transmit and/or receive data using a short-range antenna 130. More particularly, the dedicated restaurant transceiver 115 may be configured to transmit food/beverage menu content to one or more mobile terminals, such as mobile terminals 125a to 125d, and receive a menu selection designating at least one food/beverage item from one or more of the mobile terminals over a wireless data connection. A wireless data connection may be established between the restaurant transceiver 115 and a mobile terminal responsive to receiving a menu request from a mobile terminal. For example, a mobile terminal 125a may be wirelessly linked to the restaurant transceiver 115 directly via an ad hoc wireless data connection, such as an infrared, Bluetooth, or Wi-Fi connection. Alternatively, the mobile terminal 125a may be wirelessly linked to the restaurant transceiver 115 through a public land mobile network (PLMN) such as a cellular radiotelephone network. An appropriately enabled mobile terminal, such as mobile terminal 125a, may thus receive food/beverage menu content from the restaurant transceiver 115 and transmit a menu selection designating at least one food/beverage item to the restaurant transceiver 115 responsive to the received menu content using the wireless data connection. As used herein, “menu content”, or more generally, a “menu”, may include a listing of one or more food/beverage items.

The restaurant intranet 120 may be coupled to the dedicated restaurant transceiver 115. The restaurant intranet 120 may include a plurality of servers, displays, cash registers, and/or other restaurant-related equipment which may be used to receive and/or process food/beverage orders from customers. Accordingly, the restaurant intranet 120 may receive the menu selection from the dedicated restaurant transceiver 115 and supply the received menu selection to the restaurant employees, so that they may prepare the food/beverage items designated by the menu selection for the customer.

As used herein, a “customer” mobile terminal may include a mobile terminal that belongs to and/or is owned by a customer/patron of the food/beverage establishment. For example, the customer mobile terminals 125a to 125d may be laptop computers, notebook computers, handheld computers, personal communications system (PCS) terminals, personal digital assistants (PDA), pagers, and/or radiotelephones; however, the mobile terminals 125a to 125d need not all be identical. For example, one of the mobile terminals 125a to 125d may be a radiotelephone; another of the mobile terminals 125a to 125d may be a laptop, a notebook, and/or a handheld computer; and/or still another of the mobile terminals 125a to 125d may be a PDA. Alternatively, two or more of the mobile terminals 125a to 125d may be of a same type.

The customer mobile terminals 125a to 125d may each include a wireless local area network interface transceiver that supports formation of an ad hoc wireless local area network including the dedicated restaurant transceiver 115, mobile terminals 125a to 125d, and/or additional devices. For example, a mobile terminal 125a may use a wireless local area network transceiver to establish an ad hoc wireless data connection with the restaurant transceiver 115 via the short-range antenna 130. The wireless local area network interface transceiver, for example, may be provided according to a Wi-Fi (IEEE 802.11) standard and/or a Bluetooth standard operating in the Personal Area Network (PAN) mode. The Bluetooth standard is discussed, for example, by Sailesh Rathi in the reference entitled “Blue Tooth Protocol Architecture” from Dedicated Systems Magazine, 2000 Q4, pages 28-33, the disclosure of which is hereby incorporated herein in its entirety by reference. Alternatively, the wireless local area network may be provided using infrared couplings between the mobile terminals 125a to 125d and the restaurant transceiver 115. Accordingly, food/beverage menu content and/or menu selections can be transmitted and/or received between the restaurant transceiver 115 and the mobile terminals 125a to 125d using the wireless local area network.

Alternatively, each of the customer mobile terminals 125a to 125d may include the functionality of a PLMN transceiver and/or wireless modem. As such, a mobile terminal 125a may use a PLMN transceiver to establish a wireless data connection with the dedicated restaurant transceiver 115 through a network 140 connected to the restaurant intranet 120, such as a PLMN, using a packet switched connection such as that provided by the Enhanced Data GSM Environment (EDGE) standard, the General Packet Radio Service (GPRS) standard, and/or the Universal Mobile Telecommunications System (UMTS) standard. Alternatively, the mobile terminal 125a may establish a wireless connection with the restaurant transceiver 115 through the network 140 using a circuit switched connection. The network 140 may represent a global network, such as the Internet, or other publicly accessible network. The network 140 may also, however, represent a wide area network, a local area network, an Intranet, or other private network, which may not accessible by the general public. Furthermore, the network 140 may represent a combination of one or more wired and/or wireless public and/or private networks and/or virtual private networks (VPN). Accordingly, food/beverage menu content and/or menu selections can be transmitted and/or received between the restaurant transceiver 115 and the mobile terminals 125a to 125d via the network 140.

As a further alternative, each of the customer mobile terminals 125a to 125d may include both a wireless local area network transceiver and a PLMN transceiver. Accordingly, a wireless data connection may be established between the dedicated restaurant transceiver 115 and the mobile terminals 125a to 125d using a wireless local area network transceiver, a PLMN transceiver, or some combination of the two. For example, mobile terminal 125a may use the wireless local area network transceiver to establish an ad hoc wireless data connection with the restaurant transceiver 115, while the PLMN transceiver may be used for other applications supported by the mobile terminal 125a, such as voice-call applications. Alternatively, mobile terminal 125a may use the PLMN transceiver to establish a wireless data connection with the restaurant transceiver 115, while the wireless local area network transceiver may be used for other applications. As an additional alternative, mobile terminal 125a may use both the wireless local area network transceiver and the PLMN transceiver to establish wireless data connections with the restaurant transceiver 115 based on reliability, convenience, and/or other factors. Furthermore, the mobile terminals 125a to 125d need not all establish respective data connections with the restaurant transceiver 115 by the same means. For example, mobile terminal 125a may establish an ad hoc wireless data connection with the restaurant transceiver 115 using a wireless local area network transceiver, while mobile terminal 125b may establish a wireless data connection with the restaurant transceiver 115 using a PLMN transceiver.

Although FIG. 1 illustrates an exemplary wireless network, it will be understood that the present invention is not limited to such configurations, but is intended to encompass any configuration capable of carrying out the operations described herein. For example, in some embodiments, the dedicated restaurant transceiver 115 and/or the restaurant intranet 120 may not be connected to the network 140, and all data connections between the restaurant transceiver 115 and the mobile terminals 125a to 125d may be respective ad hoc wireless data connections established using respective wireless local area network transceivers.

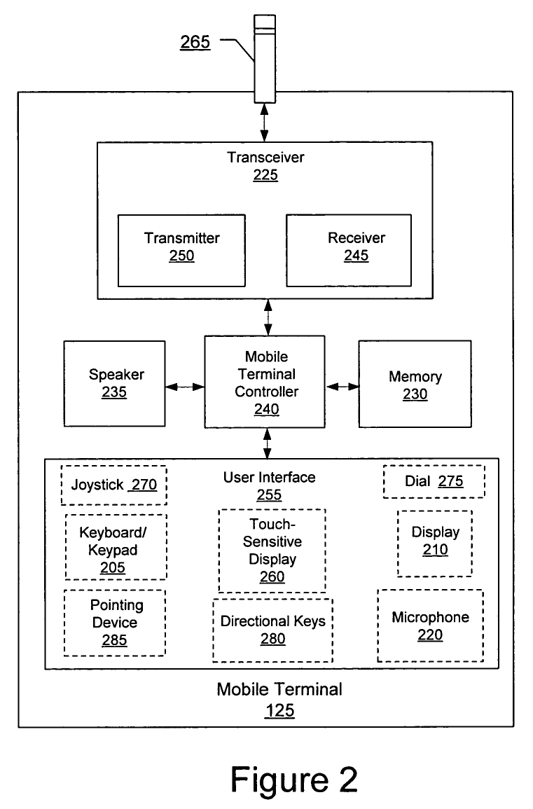

FIG. 2 is a block diagram illustrating embodiments of a mobile terminal 125 according to some embodiments of the present invention. In some embodiments, the mobile terminal 125 may correspond to one of the customer mobile terminals 125a to 125d of FIG. 1. As shown in FIG. 2, the mobile terminal 125 includes a transceiver 225, an antenna 265, a controller 240, memory 230, a speaker 235, and a user interface 255. Depending on functionalities offered by the mobile terminal 125, the user interface 255 may include a microphone 220, a display 210 (such as a liquid crystal display), a joy stick 270, a keypad 205, a touch sensitive display 260, a dial 275, a directional key(s) 280, and/or a pointing device 285 (such as a mouse, track ball, touch pad, etc.). However, additional and/or fewer elements of the user interface 255 may actually be provided. For example, the touch sensitive display 260 may be provided in a PDA without a display 210, without a keypad 205, and/or without a pointing device 285.

The mobile terminal transceiver 225 includes a transmitter 250 and a receiver 245. The transceiver 225 may be configured to receive food/beverage menu content from a restaurant transceiver, such as the dedicated restaurant transceiver 115, using the receiver 245, and transmit a menu selection designating at least one food/beverage item to the restaurant transceiver using the transmitter 250. The transceiver 225 may be further configured to transmit a menu request for the food/beverage menu content to the dedicated restaurant transceiver. The transceiver 225 may include a wireless local area network interface transceiver and/or a PLMN transceiver. Accordingly, the transceiver 225 may be configured to transmit the menu request by calling a connection number displayed in the food/beverage establishment, such as on the menu display 105, using the PLMN transceiver. Also, the transceiver 225 may be configured to transmit the menu request responsive to receiving a message, such as a Short Message Service (SMS) message, from the restaurant transceiver. Alternatively, the transceiver 225 may be configured to transmit the menu request according to a wireless local area networking standard, such as Wi-Fi and/or Bluetooth, using the wireless local area network interface transceiver. Network security for the wireless local area network (such as encryption and/or authentication) may be provided according to the applicable network standard being used. While a single antenna 265 is illustrated in FIG. 2 by way of example, separate antennas may be provided for the PLMN transceiver and/or the wireless network interface transceiver. Alternatively, multiple antennas may be shared by the PLMN transceiver and wireless network interface transceiver, and/or multiple antennas may be provided for one or both of the PLMN transceiver and wireless network interface transceiver.

Still referring to FIG. 2, the controller 240 is coupled to the transceiver 225, the memory 230, the speaker 235, and the user interface 255. The controller 240 may be, for example, a commercially available or custom microprocessor that is configured to coordinate and manage operations of the transceiver 225, the memory 230, the speaker 235, and the user interface 255. As such, the mobile terminal controller 240 may be configured to establish an ad hoc wireless data connection, such as an infrared, Bluetooth, and/or Wi-Fi connection, with a restaurant transceiver, such as the dedicated restaurant transceiver 115 of FIG. 1, using the transceiver 225. Alternatively, the mobile terminal controller 240 may be configured to establish a wireless data connection with a restaurant transceiver using a PLMN connection. The controller 240 may also be configured to direct food/beverage menu content received from the restaurant transceiver to the display 210. In some embodiments, the controller 240 may be configured to provide account information associated with the mobile terminal 125 to the restaurant transceiver to pay for the at least one food/beverage item. In other embodiments, the controller 240 may be configured to submit a menu request for a first language version of the food/beverage menu content to the transceiver 225 for transmission to the restaurant transceiver. For example, a Spanish-speaking customer may request a Spanish-language version of the food/beverage menu content via the controller 240.

Although FIG. 2 illustrates an exemplary mobile terminal that may be used to order food/beverage items in a food/beverage establishment, it will be understood that the present invention is not limited to such a configuration but is intended to encompass any configuration capable of carrying out the operations described herein. For example, although the memory 230 is illustrated as separate from the controller 240, the memory 230 or portions thereof may be considered as a part of the controller 240. More generally, while particular functionalities are shown in particular blocks by way of illustration, functionalities of different blocks and/or portions thereof may be combined, divided, and/or eliminated.

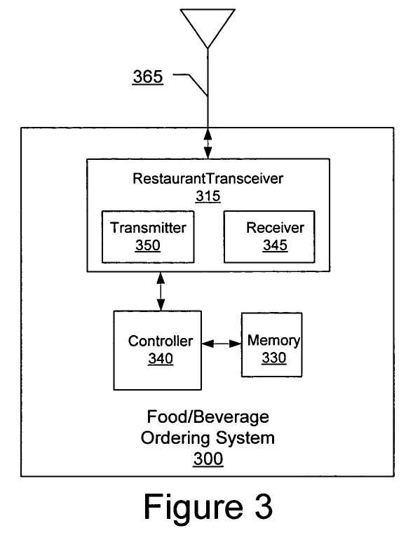

FIG. 3 is a block diagram illustrating embodiments of a food/beverage ordering system 300 according to some embodiments of the present invention. Referring now to FIG. 3, the food/beverage ordering system 300 includes a controller 340 coupled to a dedicated restaurant transceiver 315 (including a transmitter 350 and a receiver 345) and memory 330. In some embodiments, the restaurant transceiver 315 may correspond to the restaurant transceiver 115 of FIG. 1. The controller 340 may be, for example, a commercially available or custom microprocessor that is configured to coordinate and manage operations of the restaurant transceiver 315 and the memory 330. The dedicated restaurant transceiver 315 may include a wireless local area network interface transceiver and/or a PLMN transceiver, similar to the transceiver 225 of the mobile terminal 125 of FIG. 2 as described above. The food/beverage ordering system 300 may also include an antenna 365, which may be similar to the antenna 265 of the mobile terminal 125 of FIG. 2 as described above. In some embodiments, the food/beverage ordering system 300 may be connected to a restaurant intranet including displays, cash registers, and/or other restaurant-related equipment which may be used to receive and/or process food/beverage orders from customers, such as the restaurant intranet 120 of FIG. 1.

Accordingly, the food/beverage ordering system controller 340 may be configured to establish an ad hoc wireless data connection, such as an infrared, Bluetooth, and/or Wi-Fi connection, with a mobile terminal, such as the mobile terminal 125 of FIG. 2, using the dedicated restaurant transceiver 315. Alternatively, the food/beverage ordering system controller 340 may be configured to establish a wireless data connection with a mobile terminal using a PLMN connection. The dedicated restaurant transceiver 315 may be configured to transmit food/beverage menu content to a mobile terminal in the food/beverage establishment over the wireless data connection and receive a menu selection from the mobile terminal designating at least one food/beverage item over the wireless data connection. The restaurant transceiver 315 may be further configured to receive a menu request from the mobile terminal, and the controller 340 may be configured to establish the wireless data connection responsive to the received menu request. For example, the restaurant transceiver 315 may be configured to transmit a message, such as a SMS message, to the mobile terminal and receive the menu request from the mobile terminal responsive to the transmitted message. Alternatively, the restaurant transceiver 315 may be configured to receive a call from the mobile terminal at a number displayed in the food/beverage establishment, and the controller 340 may be configured to accept the call to establish the wireless data connection.

The food/beverage ordering system controller 340 may be further configured to detect the mobile terminal within a predetermined proximity of the restaurant transceiver 315 and transmit a message to the mobile terminal responsive to the detection using the restaurant transceiver 315. The menu request may be received from the mobile terminal responsive to the transmitted message. The controller 340 may also be configured to display the received menu selection at a kitchen/preparation area of the food/beverage establishment using the restaurant intranet. In addition, the controller 340 may be configured to transmit a signal to the mobile terminal using the restaurant transceiver 315 when the at least one food/beverage item designated by the menu selection is ready. In some embodiments, the controller 340 may be configured to identify an account associated with the mobile terminal and bill the account based on the transmitted menu selection. In other embodiments, the controller 340 may be configured to provide a first language version of the food/beverage menu content to the mobile terminal using the wireless data connection, responsive to receiving a menu request for the first language version of the food/beverage menu content from the mobile terminal.

In addition, the dedicated restaurant transceiver may be configured to receive a plurality of menu selections from a respective plurality of mobile terminals in the food/beverage establishment, such as customer mobile terminals 125a to 125d of FIG. 1. The food/beverage ordering system controller 340 may be configured to form a virtual queue based on the order of receipt of each menu selection. For example, the virtual queue may list the menu selections and the respective mobile terminals from which each menu selection was transmitted, so that employees of the food/beverage establishment can prepare the food/beverage items designated by each menu selection in the order in which they were received. The controller 340 may be further configured to form an aggregate queue by combining the virtual queue with a queue of manually-entered orders, such as orders taken in-person from customers at a counter in the food/beverage establishment. For example, the aggregate queue may list both the manually-entered orders and the menu selections from the mobile terminals based on the order in which they were received. In some embodiments, the controller 340 may be configured to transmit an approximate food/beverage wait time to a mobile terminal using the restaurant transceiver 315, based on the position of the menu selection received from the mobile terminal in the aggregate queue.

Although FIG. 3 illustrates an exemplary food/beverage ordering system that may be used to take food/beverage orders from one or more mobile terminals in a food/beverage establishment, it will be understood that the present invention is not limited to such a configuration but is intended to encompass any configuration capable of carrying out the operations described herein.

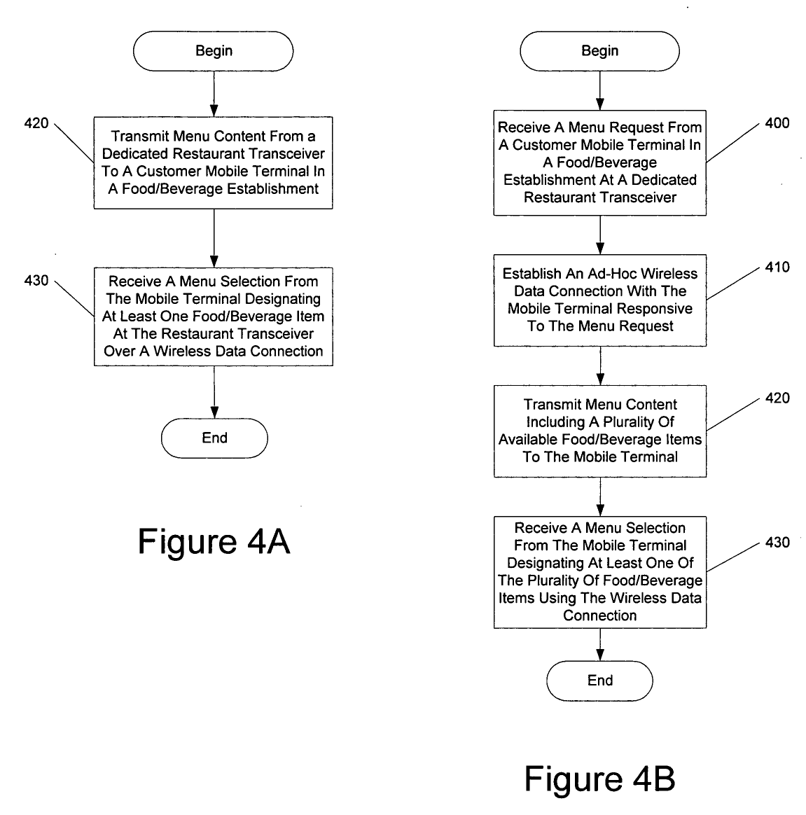

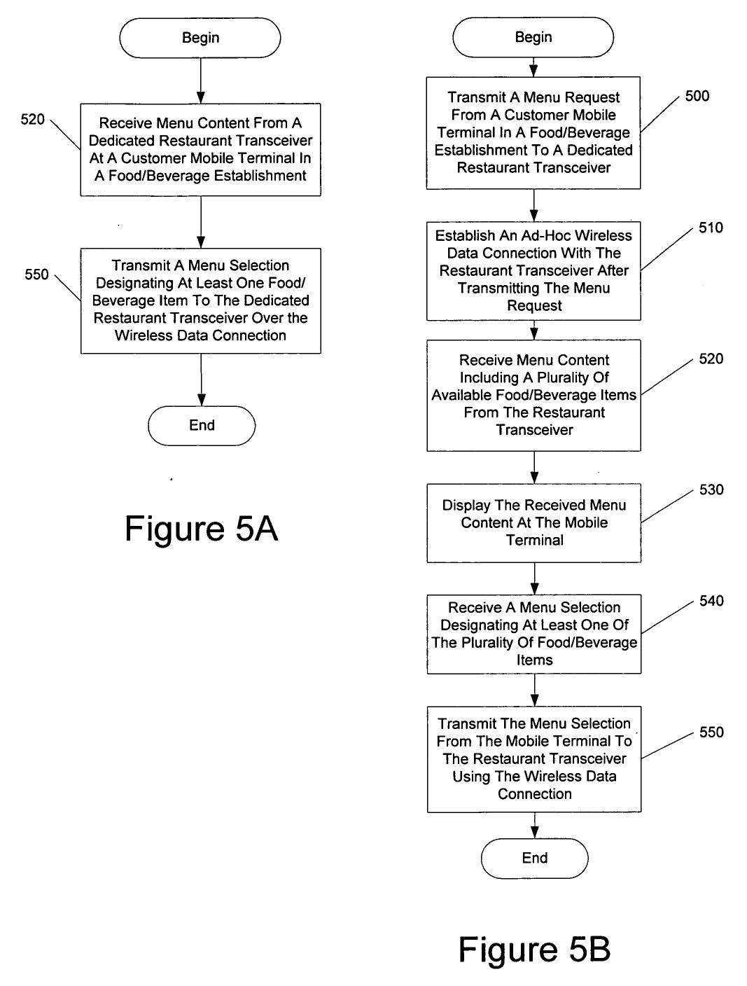

Exemplary operations for handling food/beverage orders at a food/beverage establishment in accordance with some embodiments of the present invention will now be described with reference to the flowcharts of FIGS. 4A-4B and FIGS. 5A-5B.

FIGS. 4A and 4B illustrate exemplary operations of food/beverage ordering systems and methods according to embodiments of the present invention. Referring now to FIG. 4A, operations begin at block 420 where food/beverage menu content is transmitted from a dedicated restaurant transceiver to a customer mobile terminal in a food/beverage establishment. The food/beverage menu content may include a plurality of food/beverage items that are available for customers to order at the food/beverage establishment. Responsive to the transmitted food/beverage menu content, a menu selection designating at least one food/beverage item is received from the customer mobile terminal at the dedicated restaurant transceiver over a wireless data connection at block 430.

Additional operations of food/beverage ordering systems and methods according to some embodiments of the present invention will now be described with reference to FIG. 4B. As shown in FIG. 4B, a menu request is received from a customer mobile terminal in a food/beverage establishment at a dedicated restaurant transceiver at block 400. For example, the menu request may be a request for food/beverage menu content. Also, the menu request from the mobile terminal may designate particular food/beverage menu content, such as a desired language version of the food/beverage menu content. The menu request may be initiated by the mobile terminal, such as by calling a connection number displayed in the food/beverage establishment. Alternatively, the menu request may be received responsive to a message transmitted from the restaurant transceiver, such as an SMS text message. For example, the customer mobile terminal may be detected when it moves within a predetermined proximity of the dedicated restaurant transceiver, and the restaurant transceiver may transmit the message to the mobile terminal responsive to the detection.

Still referring to FIG. 4B, a wireless data connection is established with the customer mobile terminal responsive to the menu request (block 410). For example, the wireless data connection may be an ad-hoc wireless data connection, such as an infrared, Bluetooth, and/or Wi-Fi connection. Food/beverage menu content including a plurality of available food/beverage items is transmitted to the mobile terminal (block 420), and a menu selection designating at least one of the plurality of food/beverage items is received from the mobile terminal at the dedicated restaurant transceiver using the wireless data connection (block 430). The received menu selection may be displayed in a kitchen/preparation area of the food/beverage establishment so that employees of the food/beverage establishment may prepare and/or provide the food/beverage items designated by the menu selection.

In some embodiments, a virtual queue may be formed after receiving a plurality of menu selections from a respective plurality of customer mobile terminals in the food/beverage establishment. The virtual queue may include a list of the customer mobile terminals and/or received menu selections based on the order of receipt of each menu selection. In addition, an aggregate queue may be formed to combine manually-entered orders, such as those taken in-person from customers of the food/beverage establishment, with the menu selections received from the plurality of mobile terminals. The aggregate queue may thereby be formed based on the order of receipt of each menu selection and based on the order of receipt of each manually-entered order. An approximate food/beverage order wait time may be transmitted to a respective mobile terminal based on its position in the aggregate queue.

In addition, after receiving the menu selection (block 430), an account associated with the mobile terminal may be identified. The account may be a credit card account, a service provider account, and/or other profile associated with the mobile terminal. Once the account information has been verified, the account may be billed based on the particular food/beverage items designated in the received menu selection. The food/beverage items designated by the received menu selection may then be served to the user/owner of the mobile terminal.

FIGS. 5A and 5B illustrate operations of a mobile terminal and methods according to embodiments of the present invention. Referring now to FIG. 5A, operations begin at block 520 where food/beverage menu content from a dedicated restaurant transceiver is received at a customer mobile terminal in a food/beverage establishment. The food/beverage menu content may include a plurality of food/beverage items that are available for customers to order at the food/beverage establishment. Responsive to the received food/beverage menu content, a menu selection designating at least one food/beverage item is transmitted from the customer mobile terminal to the dedicated restaurant transceiver over a wireless data connection at block 550.

Additional operations of mobile terminals and methods according to some embodiments of the present invention will now be described with reference to FIG. 5B. As shown in FIG. 5B, a menu request is transmitted from a customer mobile terminal in a food/beverage establishment to a dedicated restaurant transceiver at block 500. The menu request may be a request for food/beverage menu content. Also, the menu request may designate particular food/beverage menu content, such as a desired language version of the food/beverage menu content. The menu request may be initiated by the mobile terminal, such as by calling a connection number displayed in the food/beverage establishment. Alternatively, the menu request may be transmitted responsive to a message received from the restaurant transceiver, such as an SMS text message. For example, the customer mobile terminal may be detected when it moves within a predetermined proximity of the dedicated restaurant transceiver, and the mobile terminal may receive the message from the restaurant transceiver responsive to the detection.

Still referring to FIG. 5B, after transmitting the menu request, a wireless data connection is established with the dedicated restaurant transceiver (block 510). For example, the wireless data connection may be an ad-hoc wireless data connection, such as an infrared, Bluetooth, and/or Wi-Fi connection. Food/beverage menu content including a plurality of available food/beverage items is received from the restaurant transceiver (block 520) and displayed at the mobile terminal (block 530). A menu selection designating at least one of the plurality of food/beverage items is received at the mobile terminal (block 540), for example, from a customer/user of the mobile terminal who desires to place an order at the food/beverage establishment. The menu selection is then transmitted from the customer mobile terminal to the dedicated restaurant transceiver using the wireless data connection (block 550). In some embodiments, account information associated with the mobile terminal is also transmitted to the restaurant transceiver to pay for the food/beverage items designated by the menu selection. The account information may be a credit card number, a service provider account, and/or other profile associated with the mobile terminal. The mobile terminal may also receive an approximate food/beverage wait time from the restaurant transceiver based on an order of receipt of the menu selection. When the food/beverage items designated by the menu selection is ready, the mobile terminal may receive a signal from the restaurant transceiver indicating that the user's order is ready.

Exemplary operations for ordering food/beverage items at a food/beverage establishment using a mobile terminal in accordance with some embodiments of the present invention are illustrated by the following examples. These examples shall be regarded as merely illustrative and shall not be construed as limiting the invention.

In one example, Jerry enters his favorite coffee shop, Starbucks, to meet some friends. As Jerry approaches Starbucks, Jerry receives a text message from the Starbucks ordering system transceiver on his mobile phone asking if he would like to see a menu. Noticing the long line at the Starbucks counter and fearing that he may not find an unoccupied table by the time he waits in line, Jerry answers “YES”, and a menu request is sent from Jerry's phone to the Starbucks ordering system transceiver. The Starbucks transceiver and Jerry's phone then establish an ad-hoc wireless data connection, such as a Bluetooth connection, and the Starbucks transceiver transmits the Starbucks menu content to Jerry's phone over the wireless data connection. The menu content is received and displayed at Jerry's phone. As Jerry looks over the menu using the display of his phone, he sits down at a table, being sure to save two extra seats for his friends. Jerry decides that he would like a White Chocolate Mocha. Jerry enters his selection on his phone, and Jerry's menu selection is transmitted to the Starbucks transceiver over the wireless data connection. The Starbucks transceiver receives Jerry's menu selection and places Jerry's order in a queue, which also includes orders from the people at the counter. The Starbucks ordering system also displays “1 White Chocolate Mocha” on monitors in the preparation area behind the counter. In the meantime, Jerry's friends arrive, and the three begin talking about nothing. One of the Starbuck's employees prepares Jerry's coffee based on the order in which the menu selection was received, and enters that the order has been completed on a cash register terminal at the counter. The Starbucks transceiver then transmits a signal to Jerry's phone, indicating that his order is ready. Upon receiving the signal, Jerry's phone vibrates, letting him know that his coffee is waiting for him at the counter. When he's ready, Jerry picks up his order, pays at the counter, and returns to the table.

In another example, Carrie is attempting to order a drink at her favorite nightclub, Cheers. However, as Cheers is very popular, a large crowd is gathered around the bar, and Carrie is unable to get the bartender's attention. While waiting at the bar, Carrie runs into an ex-boyfriend, John. Anxious to avoid conversation with John, Carrie makes up an excuse to leave and gives up her position at the bar. As she walks away, Carrie notices a sign above the bar that reads, “To order via your mobile phone, dial *DRINK.” Carrie dials the displayed connection number on her mobile phone, thereby sending a menu request from Carrie's phone to the Cheers ordering system transceiver. The Cheers transceiver and Carrie's phone establish an ad-hoc wireless data connection between the two responsive to the menu request, and the Cheers transceiver transmits the Cheers drink menu to Carrie's phone over the wireless data connection. The drink menu, including available alcoholic beverages served at Cheers, is received and displayed at Carrie's phone. As Carrie looks over the menu using the display of her phone, she decides that she's in the mood for an apple martini and enters her selection on her phone. Carrie's drink order is transmitted over the wireless data connection to the Cheers transceiver, which receives Carrie's drink order and places the order in a queue displayed on a monitor behind the bar. Meanwhile, some of Carrie's friends arrive, and the four sit down at a table. The bartender prepares Carrie's martini based on the order in which it was received, and enters that the order has been completed on a cash register terminal behind the bar. The Cheers transceiver then transmits a signal to Carrie's phone indicating that her order is ready and asking whether she would like to pay by credit card. Upon receiving the signal, Carrie's selects “YES”, and enters her credit card number on her phone. Carrie's credit card number is securely transmitted to the Cheers transceiver, which verifies the account number and bills Carrie's credit card $12.50 for her apple martini. Carrie then pushes her way back up to the bar to pick up her martini. In doing so, Carrie notices that John is still at the bar attempting to get the bartender's attention. Amused, Carrie picks up her drink and returns to her friends.

In the drawings and specification, there have been disclosed typical preferred embodiments of the invention and, although specific terms are employed, they are used in a generic and descriptive sense only and not for purposes of limitation, the scope of the invention being set forth in the following claims.

1. A method of taking a food/beverage order at a food/beverage establishment, the method comprising:
receiving a menu selection designating at least one food/beverage item from a customer mobile terminal in the food/beverage establishment over a wireless data connection responsive to transmitting food/beverage menu content from a dedicated restaurant transceiver to the mobile terminal.

2. A method according to claim 1, wherein receiving a menu selection comprises:
receiving a menu request from a customer mobile terminal in the food/beverage establishment at a dedicated restaurant transceiver;
establishing an ad-hoc wireless data connection with the mobile terminal responsive to the menu request;
transmitting food/beverage menu content including a plurality of available food/beverage items to the mobile terminal; and
receiving a menu selection designating at least one of the plurality of food/beverage items from the mobile terminal at the dedicated restaurant transceiver using the ad-hoc wireless data connection.

3. The method of claim 2, wherein transmitting food/beverage menu content comprises:
transmitting food/beverage menu content to the mobile terminal using the ad-hoc wireless data connection.

4. The method of claim 2, further comprising:
receiving a plurality of menu selections from a respective plurality of customer mobile terminals in the food/beverage establishment; and
forming a virtual queue comprising a list of the plurality of customer mobile terminals and/or received menu selections based on an order of receipt of each menu selection.

5. The method of claim 4, further comprising:
forming an aggregate queue comprising a combination of the virtual queue and a queue of manually-entered orders based on the order of receipt of each menu selection and based on an order of receipt of each manually-entered order.

6. (canceled)

7. The method of claim 2, further comprising:
detecting the mobile terminal within a predetermined proximity of the restaurant transceiver; and
transmitting a message to the mobile terminal responsive to detecting the mobile terminal,
wherein receiving a menu request from the mobile terminal comprises receiving a menu request from the mobile terminal responsive to the transmitted message.

8. The method of claim 2, further comprising:
displaying a connection number in the food/beverage establishment,
wherein receiving a menu request from the mobile terminal comprises receiving a call from the mobile terminal at the displayed number.

9. The method of claim 2, wherein the food/beverage establishment comprises at least one of a fast food restaurant, a coffee shop, and/or a bar, and wherein the wireless data connection comprises at least one of an infrared, Bluetooth, Wi-Fi, and/or PLMN connection.

10-13. (canceled)

14. The method of claim 2, wherein receiving a menu request comprises receiving a menu request for a first language version of the food/beverage menu content, and wherein transmitting food/beverage menu content comprises transmitting the first language version of the food/beverage menu content responsive to receiving the menu request.

15-23. (canceled)

24. A food/beverage ordering system for taking a food/beverage order at a food/beverage establishment, comprising:
a dedicated restaurant transceiver configured to transmit food/beverage menu content to a customer mobile terminal in the food/beverage establishment and receive a menu selection designating at least one food/beverage item from the mobile terminal over an ad-hoc wireless data connection.

25. The system of claim 24, wherein the restaurant transceiver is configured to transmit the food/beverage menu content to the mobile terminal over the wireless data connection and receive the menu selection responsive to the transmitted food/beverage menu content.

26. The system of claim 24, wherein the restaurant transceiver is further configured to receive a menu request from the mobile terminal, and further comprising:
a controller configured to establish the ad-hoc wireless data connection with the mobile terminal responsive to the received menu request.

27. The system of claim 26, wherein the restaurant transceiver is configured to receive a menu request for a first language version of the food/beverage menu content from the mobile terminal, wherein the controller is configured to provide the first language version of the food/beverage menu content responsive to the received menu request, and wherein the restaurant transceiver is configured to transmit the first language version of the food/beverage menu content to the mobile terminal using the ad-hoc wireless data connection.

28. The system of claim 26, wherein the controller is further configured to identify an account associated with the mobile terminal and bill the account based on the received menu selection.

29. The system of claim 26, further comprising:
a menu display configured to display a connection number,
wherein the restaurant transceiver is configured to receive a call from the mobile terminal at the displayed number, and wherein the controller is configured to accept the call to establish the ad-hoc wireless data connection.

30. The system of claim 26, wherein the restaurant transceiver is further configured to transmit a message to the mobile terminal and receive the menu request from the mobile terminal responsive to the transmitted message.

31. The system of claim 30, wherein the controller is configured to detect the mobile terminal within a predetermined proximity of the restaurant transceiver, and wherein the restaurant transceiver is configured to transmit the message to the mobile terminal responsive to detecting the mobile terminal.

32. (canceled)

33. (canceled)

34. The system of claim 26, wherein the restaurant transceiver is configured to receive a plurality of menu selections from a respective plurality of mobile terminals in the food/beverage establishment, and wherein the controller is configured to form a virtual queue comprising a list of the plurality of mobile terminals and/or received menu selections based on an order of receipt of each menu selection.

35. The system of claim 34, wherein the controller is further configured to form an aggregate queue comprising a combination of the virtual queue and a queue of manually-entered orders based on the order of receipt of each menu selection and based on an order of receipt of each manually-entered order.

36-43. (canceled)

44. A computer program product for ordering food/beverage items at a food/beverage establishment, the computer program product comprising:
a computer readable storage medium having computer readable program code embodied in the medium, the computer readable program code comprising:
computer readable program code configured to transmit a menu request from a customer mobile terminal in the food/beverage establishment to a dedicated restaurant transceiver;
computer readable program code configured to establish an ad-hoc wireless data connection with the dedicated restaurant transceiver after transmitting the connection request;
computer readable program code configured to receive food/beverage menu content including a plurality of available food/beverage items from the dedicated restaurant transceiver;
computer readable program code configured to display the received food/beverage menu content at the mobile terminal;
computer readable program code configured to receive a menu selection designating at least one of the plurality of food/beverage items; and
computer readable program code configured to transmit the menu selection from the mobile terminal to the dedicated restaurant transceiver using the ad-hoc wireless data connection.
